(19) United States
(12) Patent Application Publication
(10) Pub. No.: US 2024/0174908 A1
(43) Pub. Date: May 30, 2024

(54) BORON NITRIDE POWDER AND RESIN COMPOSITION

(71) Applicant: DENKA COMPANY LIMITED, Tokyo (JP)

(72) Inventors: Yusuke SASAKI, Tokyo (JP); Kenji MIYATA, Tokyo (JP); Kei KUBOBUCHI, Tokyo (JP); Tomonari MIYAZAKI, Tokyo (JP)

(73) Assignee: DENKA COMPANY LIMITED, Tokyo (JP)

(21) Appl. No.: 18/283,482

(22) PCT Filed: Mar. 22, 2022
(86) PCT No.: PCT/JP2022/013230

§ 371 Date: Sep. 22, 2023

(30) Foreign Application Priority Data
Mar. 25, 2021 (JP) 2021-051877

(51) Int. Cl. C09K 5/14; C01B 21/064; C08K 3/38

(52) U.S. Cl. CPC C09K 5/14; C01B 21/0646; C08K 3/38; C01P 2004/03; C01P 2004/50; C01P 2004/54; C01P 2004/61; C01P 2006/12; C01P 2006/16; C01P 2006/21; C01P 2006/32; C08K 2003/385; C08K 2201/001; C08K 2201/005

(57) ABSTRACT

A boron nitride powder that is an aggregate of boron nitride particles, wherein the boron nitride powder has a BET specific surface area of 4.6 m²/g or more, and an average pore diameter of 0.65 μm or less. A resin composition containing: the boron nitride powder, and a resin.

### TECHNICAL FIELD

The present invention relates to a boron nitride powder and a resin composition.

### BACKGROUND ART

In an electronic component such as a power device, a transistor, a thyristor, and a CPU, efficient dissipation of heat generated during use is a problem. In order to solve this problem, conventionally, an insulating layer of a printed wiring board on which an electronic component is mounted is made to have high thermal conductivity, and the electronic component or the printed wiring board is attached to a heat sink via an electrically insulating thermal interface material. Ceramic powder having high thermal conductivity is used for the insulating layer and the thermal interface material.

As the ceramic powder, a boron nitride powder having characteristics such as a high thermal conductivity, a high insulating property, and a low relative dielectric constant has attracted attention. For example, Patent Document 1 discloses a hexagonal boron nitride powder in which the ratio of the major axis to the thickness of the primary particles is 5 to 10 on average, the size of the aggregates of the primary particles is 2 μm or more and 200 μm or less in terms of average particle diameter (D50), and the bulk density is 0.5 to 1.0 g/cm³, as a hexagonal boron nitride powder in which the shape of the aggregates is more spherical to improve the filling property and powder strength.

### CITATION LIST

### Patent Literature

[Patent Literature 1] Japanese Unexamined Patent Publication No. 2011-98882

### SUMMARY OF INVENTION

### Technical Problem

In recent years, the importance of heat dissipation has further increased with an increase in the speed and integration of circuits in electronic components and an increase in the mounting density of electronic components on printed wiring boards. Therefore, a heat dissipation material having a higher thermal conductivity than ever before is required.

Hence, a main objective of the present invention is to provide a boron nitride powder enabling the realization of a heat dissipation material having an excellent thermal conductivity.

### Solution to Problem

One aspect of the present invention is a boron nitride powder that is an aggregate of boron nitride particles, in which the boron nitride powder has a BET specific surface area of 4.6 m²/g or more, and an average pore diameter of 0.65 μm or less.

The boron nitride particle may be composed of a plurality of boron nitride pieces, and the plurality of boron nitride pieces may chemically bond to each other.

In the boron nitride powder, the boron nitride particle may have an average value of crushing strengths of 8 MPa or higher.

Another aspect of the present invention is a resin composition containing the boron nitride powder and a resin.

### Advantageous Effects of Invention

According to the present invention, it is possible to provide a boron nitride powder enabling the realization of a heat dissipation material having an excellent thermal conductivity.

### BRIEF DESCRIPTION OF DRAWINGS

FIG. 1 is a SEM image of a cross section of a boron nitride particle in a boron nitride powder of Example 1.

FIG. 2 is a SEM image of the surface of the boron nitride particle in the boron nitride powder of Example 1.

FIG. 3 is a SEM image of the surface of a boron nitride particle in a boron nitride powder of Comparative Example 1.

FIG. 4 is a SEM image of a cross section of a sheet produced using the boron nitride powder of Example 1.

FIG. 5 is a SEM image of a cross section of a sheet produced using the boron nitride powder of Comparative Example 1.

### DESCRIPTION OF EMBODIMENTS

Hereinafter, embodiments of the present invention will be described in detail.

A boron nitride powder according to one aspect of the present invention is an aggregate of boron nitride particles (a powder composed of a plurality of boron nitride particles), in which the BET specific surface area is 4.6 m²/g or more, and the average pore diameter is 0.65 μm or less. The boron nitride particle is composed of, for example, a plurality of boron nitride pieces that are formed of boron nitride, and a plurality of pores satisfying the above-described average pore diameter is formed by the plurality of boron nitride pieces. The boron nitride pieces may have, for example, a scale-like shape. In this case, the lengths of the boron nitride pieces in the longitudinal direction may be, for example, 1 μm or longer and may be 10 μm or shorter.

In the boron nitride particle, it is preferable that the plurality of boron nitride pieces chemically bonds to each other from the viewpoint of enabling the realization of a heat dissipation material having a superior thermal conductivity. The fact that the plurality of boron nitride pieces has chemically bonded to each other can be confirmed from the fact that no boundaries are observed between the boron nitride pieces in the bonding portions of the boron nitride pieces using a scanning electron microscope (SEM).

The average thickness of the boron nitride pieces may be 0.30 μm or less, 0.25 μm or less, less than 0.25 μm, 0.20 μm or less or 0.15 μm or less and may be 0.05 μm or more or 0.10 μm or more. The average thickness of the boron nitride pieces is defined as the average value of the thicknesses of 40 boron nitride pieces that are measured in a SEM image obtained by observing the surface of the boron nitride particle at a magnification of 10000 times using a scanning electron microscope (SEM) and imported into image analysis software (for example, “Mac-view” manufactured by Mountech Co., Ltd.).

The average major axis of the boron nitride pieces may be 0.5 μm or more, 1.0 μm or more or 1.5 μm or more and may be 4.0 μm or less, 3.5 μm or less or 3.0 μm or less from the viewpoint of enabling the realization of a heat dissipation material having a superior thermal conductivity. The major axis means the maximum length in a direction perpendicular to the thickness direction. The average major axis of the boron nitride pieces is defined as the average value of the major axes of 40 boron nitride pieces that are measured in a SEM image obtained by observing the surface of the boron nitride particle at a magnification of 10000 times using a scanning electron microscope (SEM) and imported into image analysis software (for example, “Mac-view” manufactured by Mountech Co., Ltd.).

The average aspect ratio of the boron nitride pieces may be 7.0 or more, 8.0 or more, 9.0 or more, 9.5 or more, 10.0 or more or 10.5 or more from the viewpoint of enabling the realization of a heat dissipation material having a superior thermal conductivity. The average aspect ratio of the boron nitride pieces may be 20.0 or less, 17.0 or less or 15.0 or less. The average aspect ratio of the boron nitride pieces is defined as the average value of the aspect ratios (major axis/thickness) that are calculated from the major axis and thickness of each of 40 boron nitride pieces.

The BET specific surface area of the boron nitride powder can be measured by a BET multipoint method using a nitrogen gas according to JIS Z 8830:2013. The BET specific surface area of the boron nitride powder may be 5.0 m²/g or more, 5.5 m²/g or more, 6.0 m²/g or more, 7.0 m²/g or more or 8.0 m²/g or more from the viewpoint of enabling the realization of a heat dissipation material having a superior thermal conductivity. The BET specific surface area of the boron nitride powder may be 30.0 m²/g or less, 20.0 m²/g or less, 15.0 m²/g or less, 12.0 m²/g or less, 11.0 m²/g or less, 10.0 m²/g or less or 9.0 m²/g or less from the viewpoint of enabling the realization of a heat dissipation material having a superior thermal conductivity.

The average pore diameter of the boron nitride powder means a pore diameter at which the cumulative pore volume reaches 50/6 of the total pore volume in a pore diameter distribution (horizontal axis: pore diameter, vertical axis: cumulative pore volume) that is measured using a mercury porosimeter (for example, “AUTOPORE IV 9500” manufactured by Shimadzu Corporation) according to JIS R 1655:2003. The measurement range is set to 0.03 to 4000 atmospheres, and the pore diameter distribution is measured under gradual pressurization.

The average pore diameter of the boron nitride powder may be 0.65 μm or less, 0.50 μm or less, 0.40 μm or less or 0.30 μm or less. The BET specific surface area of the boron nitride powder is a predetermined value (for example, 4.6 m²/g) or more, and the average pore diameter of the boron nitride powder is within the above-described range, which makes it possible to consider that the boron nitride powder is an aggregate of boron nitride particles having a dense structure. Since such a boron nitride powder is easily deformed as appropriate while having an excellent crushing strength, it is possible to fill a resin while suppressing the collapse of the boron nitride particles in the boron nitride powder at the time of molding a heat dissipation material by mixing the boron nitride powder and the resin. Therefore, it is easy to produce a heat dissipation material in which a heat transfer path by boron nitride particles is maintained, and thus it is inferred that such a heat dissipation material has an excellent thermal conductivity. However, the reason for enabling the realization of a heat dissipation material having an excellent thermal conductivity is not limited to the above-described reason.

The average pore diameter of the boron nitride powder may be 0.10 μm or more or 0.15 μm or more from the viewpoint of enabling the realization of a heat dissipation material having a superior thermal conductivity. The average pore diameter of the boron nitride powder may be 0.20 μm or more. The BET specific surface area of the boron nitride powder is a predetermined value (for example, 4.6 m²/g) or more, and the average pore diameter of the boron nitride powder is within the above-described range, which makes it easy to deform the boron nitride particles as appropriate and makes the filling property of a resin excellent when the boron nitride powder and the resin have been kneaded.

Therefore, it becomes easy to suppress the generation of voids in a heat dissipation material, and thus it is inferred that such a heat dissipation material has an excellent thermal conductivity. However, the reason for enabling the realization of a heat dissipation material having an excellent thermal conductivity is not limited to the above-described reason.

The average particle diameter of the boron nitride powder may be, for example, 20 μm or longer, 40 μm or longer, 50 μm or longer, 60 μm or longer, 70 μm or longer or 80 μm or longer and may be 150 pim or shorter, 120 μm or shorter, 110 μm or shorter or 100 μm or shorter. The average particle diameter of the boron nitride powder can be measured by a laser diffraction and scattering method.

The average value of the crushing strengths of the boron nitride powder may be 8 MPa or higher, 9 MPa or higher, 10 MPa or higher or 12 MPa or higher from the viewpoint of enabling the realization of a heat dissipation material having a superior thermal conductivity by making it difficult for the boron nitride particles to collapse at the time of mixing the boron nitride powder (boron nitride particles) with a resin. The average value of the crushing strengths of the boron nitride powder may be 17 MPa or lower, 15 MPa or lower or 13 MPa or lower from the viewpoint of enabling the realization of a heat dissipation material having a superior thermal conductivity. The average value of the crushing strengths of the boron nitride powder is the average value of the crushing strengths of 20 boron nitride particles in the boron nitride powder measured using a microcompression tester (for example, “MCT-211” manufactured by Shimadzu Corporation) according to JIS R 1639-5:2007.

The amount of a nitrogen defect in the boron nitride powder may be 1.0×10¹⁸ defects/g or more and 1.0×10¹⁸ defects/g or less from the viewpoint of enabling the realization of a heat dissipation material having a superior thermal conductivity. Since the thermal conductivity of boron nitride decreases due to a defect, it is considered that a heat dissipation material having a superior thermal conductivity can be realized by decreasing the amount of a nitrogen defect. The amount of a nitrogen defect in the boron nitride powder is measured by filling 60 mg of the boron nitride powder into a quartz glass sample tube and performing electron spin resonance (ESR) measurement using a “JEM FA-200 type electron spin resonance spectrometer” manufactured by JEOL Ltd. More specifically, in the ESR measurement under the following measurement conditions, a g value is obtained, and the integrated intensity of an ESR signal that can be confirmed at g=2.00±0.04 is defined as the amount of a nitrogen defect.

### [Measurement Conditions]

Magnetic field sweep range: 0 to 3290 gauss (0 to 329 mT)
Magnetic field modulation: 5 gauss (0.5 mT)
Time constant: 0.3 s
Irradiation electromagnetic wave: 0.5 mW, approximately 9.16 GHz (the frequency of the irradiation electromagnetic wave is finely adjusted to be the resonance frequency each measurement)
Sweep time: 15 min.
Amplifier gain: 200
Mn marker: 750
Measurement environment: Room temperature (25° C.)
Standard sample: Coal standard sample manufactured by JEOL Ltd. (spin amount: 3.56×10¹³ defects/g)

The boron nitride particle may be substantially composed of boron nitride alone. The fact that the boron nitride particle is substantially composed of boron nitride alone can be confirmed from the fact that only a peak derived from boron nitride is detected in X-ray diffraction measurement.

The boron nitride powder can be produced by, for example, a production method including a nitriding step of nitriding particles containing boron carbide (hereinafter, referred to as “boron carbide particles” in some cases) to obtain particles containing boron carbonitride (hereinafter, referred to as “boron carbonitride particles” in some cases), a putting step of putting a mixture containing the particles containing boron carbonitride and a boron source containing at least one selected from the group consisting of boric acid and boron oxide into a container, and a decarburization step of decarburizing the particles containing boron carbonitride by pressurizing and heating the mixture in a state where the airtightness in the container has been enhanced, in which the amount of boron atoms in the boron source is 1.0 to 2.2 mol with respect to 1 mol of the boron carbonitride in the mixture in the putting step. That is, another embodiment of the present invention is the above-described method for producing a boron nitride powder.

In the above-described production method, the boron carbide particles in the nitriding step may be, for example, powdery (boron carbide powder). The boron carbide powder can be produced by a well-known method. Examples of a method for producing the boron carbide particles (boron carbide powder) include a method m which boric acid and acetylene black are mixed together and then heated at 1800° C. to 2400° C. for one to 10 hours in an inert gas (for example, a nitrogen gas or an argon gas) atmosphere to obtain massive boron carbide particles. The boron carbide powder can be obtained by appropriately performing pulverization, sieving, washing, impurity removal, drying and the like on the massive boron carbide particle obtained by this method.

The average particle diameter of the boron carbide powder can be adjusted by adjusting the pulverization time of the massive boron carbide particle. The average particle diameter of the boron carbide powder may be 5 μm or longer, 7 μm or longer or 10 μm or longer and may be 100 μm or shorter, 90 μm or shorter, 80 μm or shorter or 70 μm or shorter. The average particle diameter of the boron carbide powder can be measured by a laser diffraction and scattering method.

In the nitriding step, boron carbonitride particles can be obtained by putting the boron carbide particles into a container (for example, a carbon crucible) and pressurizing and heating the boron carbide particles in an atmosphere set to make a nitriding reaction progress to nitride the boron carbide particles.

The atmosphere in the nitriding step in which a nitriding reaction is made to progress may be a nitriding gas atmosphere in which the boron carbide particles are nitrided. The nitriding gas may be a nitrogen gas, an ammonia gas or the like and may be a nitrogen gas from the viewpoint of easily nitriding the boron carbide particles and the viewpoint of the cost. A single nitriding gas may be used or two or more nitriding gases may be used in combination, and the proportion of the nitrogen gas in the nitriding gas may be 95.0 vol % or more, 99.0 vol % or more or 99.9 vol % or more.

The pressure in the nitriding step may be 0.6 MPa or lower or 0.7 MPa or higher from the viewpoint of sufficiently nitriding the boron carbide particles. The pressure in the nitriding step may be 1.0 MPa or lower or 0.9 MPa or lower.

The heating temperature in the nitriding step may be 1800° C. or higher or 1900° C. or higher from the viewpoint of sufficiently nitriding the boron carbide particles. The heating temperature in the nitriding step may be 2400° C. or lower or 2200° C. or lower.

The time for performing pressurization and heating in the nitriding step may be three hours or longer, five hours or longer or eight hours or longer from the viewpoint of sufficiently nitriding the boron carbide particles. The time for performing pressurization and heating in the nitriding step may be 30 hours or shorter, 20 hours or shorter or 10 hours or shorter.

In the putting step, a mixture containing the boron carbonitride particles obtained in the nitriding step and a boron source containing at least one selected from boric acid and boron oxide is put into a container.

The container in the putting step may be, for example, a boron nitride crucible. In the putting step, the mixture may be put into, for example, the bottom portion in the container. In the putting step, the opening portion of the container may be closed with a lid or a resin may be put into a part or all of the gap between the container and the lid from the viewpoint of enhancing the airtightness of the container. The resin that is filled into the gap may be, for example, an epoxy resin, and the resin may contain a curing agent. The resin that is filled into the gap may be a resin having a high viscosity from the viewpoint of suppressing the flow of the resin.

The amount of the boron atoms in the boron source in the mixture in the putting step may be 1.0 to 2.2 mol with respect to 1 mol of the boron carbonitride in the mixture. The amount of the boron atoms may be 2.0 mol or less, 1.9 mol or less, 1.8 mol or less, 1.7 mol or less, 1.6 mol or less, 1.5 mol or less, 1.4 mol or less or 1.3 mol or less with respect to 1 mol of the boron carbonitride in the mixture from the viewpoint of enabling the realization of a heat dissipation material having a superior thermal conductivity by the boron nitride powder to be obtained. The amount of the boron atoms may be 1.1 mol or more or 1.2 mol or more with respect to 1 mol of the boron carbonitride in the mixture from the viewpoint of increasing the average thickness of the boron nitride pieces.

In the decarburization step, the mixture containing the boron carbonitride particles and the boron source is heated in an atmosphere of normal pressure or higher, whereby the boron carbonitride particles are decarburized, and boron nitride particles (boron nitride powder) can be obtained.

The atmosphere in the decarburization step may be a nitrogen gas atmosphere or may be a nitrogen gas atmosphere of normal pressure (the atmospheric pressure) or a pressurized nitrogen gas atmosphere. The pressure in the decarburization step may be 0.5 MPa or lower or 0.3 MPa or lower from the viewpoint of sufficiently decarburizing the boron carbonitride particles.

Heating in the decarburization step may be performed by, for example, increasing the temperature up to a predetermined temperature (decarburization start temperature) and then further increasing the temperature up to a predetermined temperature (holding temperature) at a predetermined temperature increase rate. The temperature increase rate at the time of increasing the temperature from the decarburization start temperature up to the holding temperature may be, for example, 5° C./minute or slower, 3° C./minute or slower or 2° C./minute or slower.

The decarburization start temperature may be 1000° C. or higher or 1100° C. or higher from the viewpoint of sufficiently decarburizing the boron carbonitride particles. The decarburization start temperature may be 1500° C. or lower or 1400° C. or lower.

The holding temperature may be 1800° C. or higher or 2000° C. or higher from the viewpoint of sufficiently decarburizing the boron carbonitride particles. The holding temperature may be 2200° C. or lower or 2100° C. or lower.

The heating time at the holding temperature may be 0.5 hours or longer, one hour or longer, three hours or longer, five hours or longer or 10 hours or longer from the viewpoint of sufficiently decarburizing the boron carbonitride particles. The heating time at the holding temperature may be 40 hours or shorter, 30 hours or shorter or 20 hours or shorter.

A step of classifying a boron nitride powder having a desired particle diameter with a sieve (classification step) may be performed on the boron nitride powder that is obtained as described above.

The boron nitride powder that is obtained as described above can be, for example, mixed with a resin and used as a resin composition. That is, still another embodiment of the present invention is a resin composition containing the boron nitride powder and a resin.

As the resin, for example, an epoxy resin, a silicone resin, silicone rubber, an acrylic resin, a phenolic resin, a melamine resin, a urea resin, an unsaturated polyester, a fluorine resin, a polyimide, a polyamide-imide, polyetherimide, polybutylene terephthalate, polyethylene terephthalate, polyphenylene ether, polyphenylene sulfide, wholly aromatic polyester, polysulfone, a liquid crystal polymer, polyethersulfone, polycarbonate, a maleimide-modified resin, an ABS (acrylonitrile-butadiene-styrene) resin, an AAS (acrylonitrile-acrylic rubber styrene) resin and AES (acrylonitrile ethylene propylene diene rubber styrene) resin can be used.

The content of the boron nitride powder may be 30 vol % or more, 40 vol % or more, 50 vol % or more or 60 vol % or more based on the total volume of the resin composition from the viewpoint of enabling the realization of a heat dissipation material having a superior thermal conductivity. The content of the boron nitride powder may be 85 vol % or less or 80 vol % or less based on the total volume of the resin composition from the viewpoint of suppressing the generation of voids at the time of molding a heat dissipation material and enabling the suppression of the degradation of the insulating properties and a decrease in the mechanical strength of the heat dissipation material.

The content of the resin may be appropriately adjusted depending on the use, required characteristics or the like of the resin composition. The content of the resin may be 15 vol % or more, 20 vol % or more, 30 vol % or more or 40 vol % or more and may be 70 vol % or less, 60 vol % or less or 50 vol % or less based on the total volume of the resin composition.

The resin composition may further contain a curing agent that cures the resin. The curing agent is appropriately selected depending on the kind of the resin. Examples of the curing agent that can be used together with an epoxy resin include phenol novolac compounds, acid anhydrides, amino compounds, imidazole compounds and the like. The content of the curing agent may be 0.5 parts by mass or more or 1.0 part by mass or more and may be 15 parts by mass or less or 10 parts by mass or less with respect to 100 parts by mass of the resin.

The resin composition may further contain other components. The other components may be, for example, a curing accelerator (curing catalyst), a coupling agent, a wetting and dispersing additive and a surface conditioner.

Examples of the curing accelerator (curing catalyst) include phosphorus-based curing accelerators such as tetraphenylphosphonium tetraphenylborate and triphenylphosphate, imidazole-based curing accelerators such as 2-phenyl-4,5-dihydroxymethylimidazole, amine-based curing accelerators such as boron trifluoride monoethylamine and the like.

Examples of the coupling agent include a silane-base coupling agent, a titanate-based coupling agent, an aluminate-based coupling agent and the like. Examples of a chemical bonding group that is contained in these coupling agents include a vinyl group, an epoxy group, an ammo group, a methacrylic group, a mercapto group and the like.

Examples of the wetting and dispersing additive include phosphate ester salt, carboxylate ester, polyester, acrylic copolymers, block copolymers and the like.

Examples of the surface conditioner include an acrylic surface conditioner, a silicone-based surface conditioner, a vinyl-based conditioner, a fluorine-based surface conditioner and the like.

The resin composition can be produced by, for example, a method for producing a resin composition including a step of preparing the boron nitride powder according to one embodiment (preparation step) and a step of mixing the boron nitride powder with a resin (mixing step). That is, far still another embodiment of the present invention is the above method for producing a resin composition. In the mixing step, in addition to the boron nitride powder and the resin, the above-described curing agent or the other components may be further mixed therewith.

The method for producing a resin composition according to one embodiment may further include a step of pulverizing the boron nitride powder (pulverization step). The pulverization step may be performed between the preparation step and the mixing step or may be performed at the same time as the mixing step (the boron nitride powder may be pulverized at the same time as the mixing of the boron nitride powder with the resin).

The resin composition can be used as, for example, a heat dissipation material. The heat dissipation material can be produced by, for example, curing the resin composition. A method for curing the resin composition is appropriately selected depending on the kind of the resin (and the curing agent that is used as necessary) contained in the resin composition. For example, in a case where the resin is an epoxy resin and the above-described curing agent is used together, the resin can be cured by heating.

### EXAMPLES

Hereinafter, the present invention will be more specifically described using examples. However, the present invention is not limited to the following examples.

### Example 1

Boron carbide particles having an average particle diameter of 55 μm were put into a carbon crucible, and the carbon crucible was heated for 20 hours under a nitrogen gas atmosphere under conditions of 2000° C. and 0.8 MPa, thereby obtaining boron carbonitride particles. 100 Parts by mass of the obtained boron carbonitride particles and 66.7 parts by mass of boric acid were mixed together using a Henschel mixer, thereby obtaining a mixture in which the amount of boron atoms in a boron source was 1.2 mol with respect to 1 mol of boron carbonitride in the mixture. The obtained mixture was put into a boron nitride crucible, the crucible was closed with a lid, and an epoxy resin was filled into all of the gap between the crucible and the lid. The boron nitride crucible filled with the mixture was heated for 10 hours in a carbon case disposed in a resistance heating furnace under conditions of normal pressure, a nitrogen gas atmosphere and a holding temperature of 2000° C., thereby obtaining coarse boron nitride particles. The obtained coarse boron nitride particles were cracked with a mortar for 10 minutes and classified with a nylon sieve having a mesh size of 109 μm, thereby obtaining boron nitride particles (boron nitride powder).

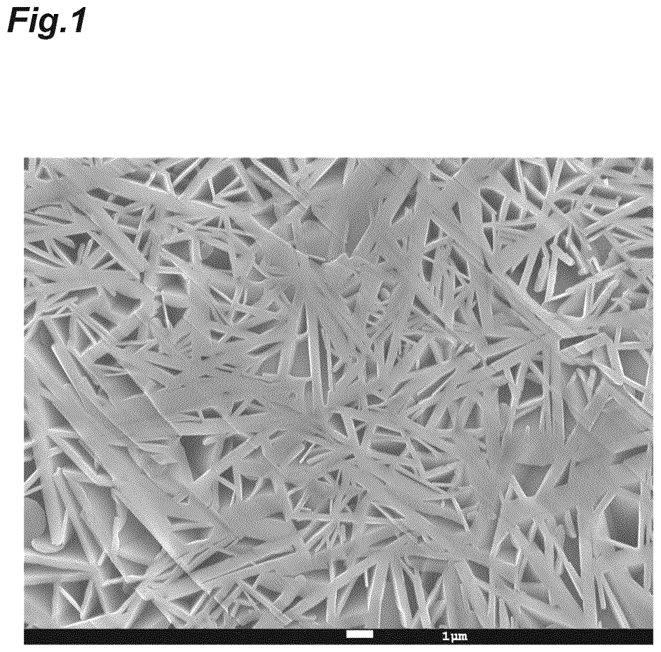

A SEM image of a cross section of the obtained boron nitride particle is shown in FIG. 1. As is clear from FIG. 1, a plurality of boron nitride pieces chemically bonded to each other in the boron nitride particle.

### Example 2

Boron nitride particles (boron nitride powder) were obtained under the same conditions as in Example 1 except that the amount of boric acid was changed so that the amount of the boron atoms in the boron source reached 1.4 mol with respect to 1 mol of boron carbonitride in the mixture. As a result of confirming a cross section of the obtained boron nitride particle with SEM, it was confirmed that a plurality of boron nitride pieces chemically bonded to each other.

### Example 3

Boron nitride particles (boron nitride powder) were obtained under the same conditions as in Example 1 except that the amount of boric acid was changed so that the amount of the boron atoms in the boron source reached 1.6 mol with respect to 1 mol of boron carbonitride in the mixture. As a result of confirming a cross section of the obtained boron nitride particle with SEM, it was confirmed that a plurality of boron nitride pieces chemically bonded to each other.

### Example 4

Boron nitride particles (boron nitride powder) were obtained under the same conditions as in Example 1 except that the amount of boric acid was changed so that the amount of the boron atoms in the boron source reached 1.8 mol with respect to 1 mol of boron carbonitride in the mixture. As a result of confirming a cross section of the obtained boron nitride particle with SEM, it was confirmed that a plurality of boron nitride pieces chemically bonded to each other.

### Example 5

Boron nitride particles (boron nitride powder) were obtained under the same conditions as in Example 1 except that the amount of boric acid was changed so that the amount of the boron atoms in the boron source reached 1.1 mol with respect to 1 mol of boron carbonitride in the mixture.

### Comparative Example 1

Boron nitride particles (boron nitride powder) were obtained under the same conditions as in Example 1 except that the amount of boric acid was changed so that the amount of the boron atoms in the boron source reached 2.7 mol with respect to 1 mol of boron carbonitride in the mixture.

### Measurement of Average Particle Diameter

The average particle diameter of the boron nitride powder was measured using a laser diffraction and scattering method particle size distribution analyzer (LS-13320) manufactured by Beckman Coulter, Inc. The measurement results of the average particle diameter are shown in Table 1.

### Measurement of Average Pore Diameter

The average pore diameter of the boron nitride powder was measured with a mercury porosimeter (manufactured by Shimadzu Corporation, AUTOPORE IV 9500) according to JIS R 1655:2003. The measurement results are shown in Table 1.

### Measurement of BET Specific Surface Area

The BET specific surface area of the boron nitride powder was measured by a BET multipoint method using a nitrogen gas according to JIS Z 8830:2013. The measurement results are shown in Table 1.

### Measurement of Thickness, Major Axis and Aspect Ratio of Boron Nitride Piece

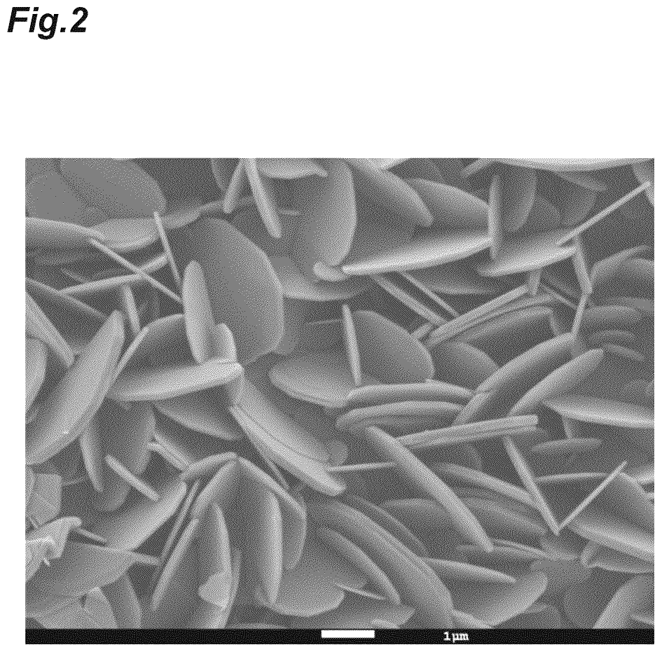

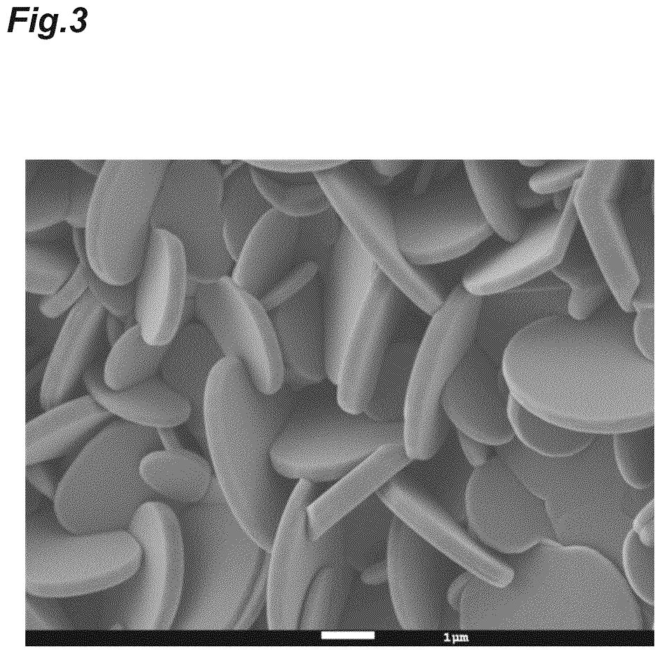

The surface of the boron nitride particle was observed at a magnification of 10000 times using a scanning electron microscope (manufactured by JEOL Ltd., JSM-7001F). A SEM image of the surface of the boron nitride particle in the obtained boron nitride powder was imported into image analysis software (manufactured by Mountech Co., Ltd., Mac-view), and the thicknesses and major axes (the maximum lengths in a direction perpendicular to the thickness direction) of the boron nitride pieces that were disposed on the surface of the boron nitride particle were measured. The thicknesses and major axes of 40 boron nitride pieces were each measured, and the average thickness and average major axis of the boron nitride pieces configuring the boron nitride particle were calculated from the measured thicknesses and major axes. In addition, the aspect ratio (major axis/thickness) of each boron nitride piece was calculated from the measured thickness and major axis, and the average aspect ratio was calculated from the aspect ratios of the 40 boron nitride pieces. The calculation results of the average thickness, the average major axis and the average aspect ratio are shown in Table 1. SEM images of the surfaces of the boron nitride particles of Example 1 and Comparative Example 1 are shown in FIG. 2 and FIG. 3, respectively.

### Measurement of Crushing Strength

For 20 boron nitride particles in each of the obtained boron nitride powders, the crushing strengths were measured according to JIS R 1639-5:2007. As a measurement device, a microcompression tester (manufactured by Shimadzu Corporation, MCT-211) was used. The crushing strength σ (unit: MPa) of each boron nitride particle was calculated using a formula of σ=α×P/(τ×d²) from a dimensionless number α(=2.48) that changes depending on the position in the particle, the crushing test force P (unit: N) and the average particle diameter d (unit: μm). The crushing strengths were measured for 20 boron nitride particles, and the average value thereof is shown in Table 1.

### Measurement of Thermal Conductivity

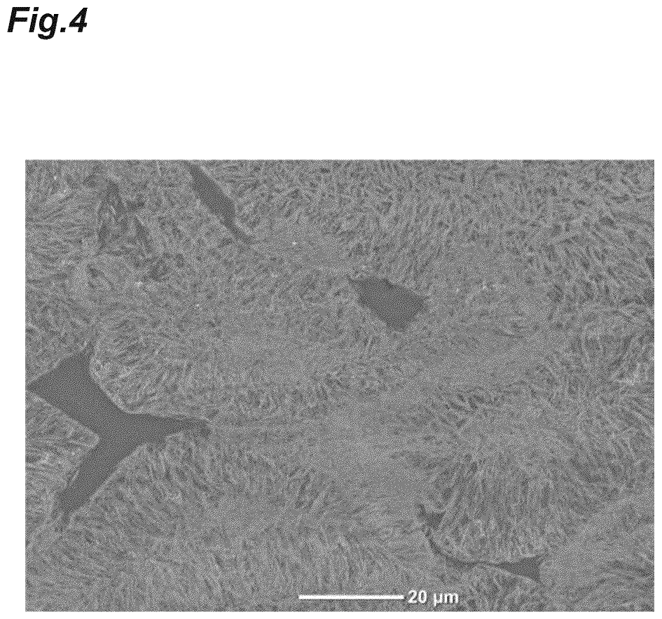

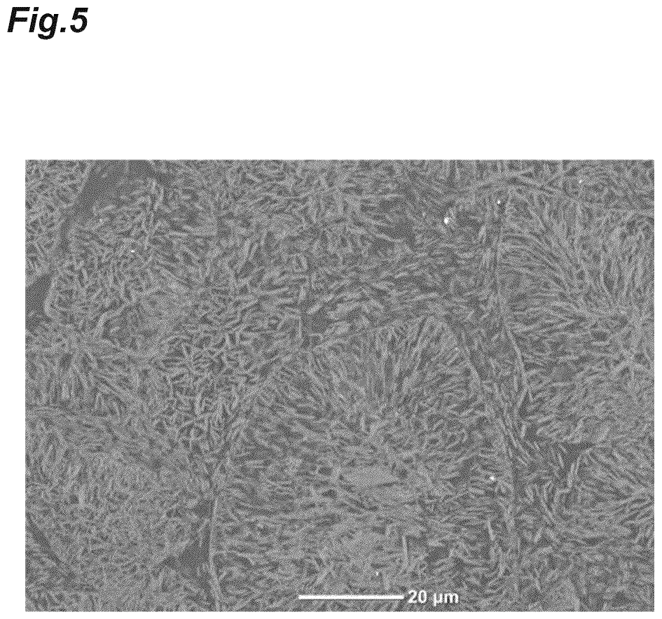

100 Parts by mass of a naphthalene-type epoxy resin (manufactured by DIC Corporation, HP4032) and 10 parts by mass of an imidazole compound (manufactured by Shikoku Chemicals Corporation, 2E4MZ—CN) as a curing agent were mixed together, and then 81 parts by mass of the boron nitride powder obtained in each of the examples and the comparative example was further mixed therewith, thereby obtaining a resin composition. This resin composition was vacuum-defoamed at 500 Pa for 10 minutes and applied onto a PET sheet such that the thickness reached 1.0 mm. After that, press heating pressurization was performed for 60 minutes under conditions of a temperature of 150° C. and a pressure of 160 kg/cm², thereby obtaining a 0.5 mm sheet-like heat dissipation material. A measurement specimen having sizes of 10 mm×10 mm was cut out from the produced heat dissipation material, and the thermal diffusivity A (m²/second) of the measurement specimen was measured by a laser flash method in which a xenon flash analyzer (manufactured by NETZSCH Group, LFA 447 NanoFlash) was used. In addition, the specific gravity B (kg/m³) of the measurement specimen was measured by the Archimedes method. In addition, the specific heat capacity C (J/(kg·K)) of the measurement specimen was measured using a differential scanning calorimeter (manufactured by Rigaku Corporation, Thermo Plus Evo DSC 8230). The thermal conductivity H(W/(m·K)) was obtained from a formula H=A×B×C using each of these physical property values. The measurement results of the thermal conductivity are shown in Table 1. SEM images of the surfaces of heat dissipation materials produced using the boron nitride powders of Example 1 and Comparative Example 1 are shown in FIG. 4 and FIG. 5, respectively.

TABLE 1

| | Example | Example | Example | Example | Example | Comparative |
|---|---|---|---|---|---|---|
| | 1 | 2 | 3 | 4 | 5 | Example 1 |
| Average particle | 89.6 | 91.0 | 91.4 | 90.5 | 89.6 | 90.0 |
| diameter | | | | | | |
| [μm] | | | | | | |
| Average pore | 0.22 | 0.30 | 0.40 | 0.46 | 0.18 | 0.68 |
| diameter | | | | | | |
| [μm] | | | | | | |
| BET specific | 8.5 | 6.8 | 5.7 | 5.3 | 11.3 | 4.5 |
| surface area | | | | | | |
| (m²/g) | | | | | | |
| Average thickness | 0.10 | 0.18 | 0.15 | 0.19 | 0.14 | 0.32 |
| of boron nitride | | | | | | |
| pieces | | | | | | |
| (μm) | | | | | | |
| Average major | 2.0 | 1.9 | 2.2 | 2.2 | 1.4 | 2.9 |
| axis of boron | | | | | | |
| nitride pieces | | | | | | |
| (μm) | | | | | | |
| Average aspect | 19.7 | 10.6 | 14.6 | 11.8 | 10.1 | 9.0 |
| ratio of boron | | | | | | |
| nitride pieces | | | | | | |
| Average value of | 12.4 | 10.0 | 9.5 | 8.9 | 16.6 | 7.8 |
| crushing strengths | | | | | | |
| (MPa) | | | | | | |
| Thermal | 18.2 | 17.9 | 17.7 | 17.8 | 17.0 | 16.2 |
| conductivity | | | | | | |
| (W/m · K) | | | | | | |

1. A boron nitride powder that is an aggregate of boron nitride particles,
wherein the boron nitride powder has a BET specific surface area of 4.6 m²/g or more, and an average pore diameter of 0.65 μm or less.

2. The boron nitride powder according to claim 1,
wherein the boron nitride particle is composed of a plurality of boron nitride pieces, and the plurality of boron nitride pieces chemically bonds to each other.

3. The boron nitride powder according to claim 1, having an average value of crushing strengths of 8 MPa or higher.

4. A resin composition comprising:
the boron nitride powder according to claim 1; and
a resin.
